(19) United States
(12) Patent Application Publication
(10) Pub. No.: US 2004/0071165 A1
(43) Pub. Date: Apr. 15, 2004

(54) Multitone hybrid FDD/TDD duplex

(76) Inventors: Arthur J. Redfern, Plano, TX (US); Cory Modlin, Chevy Chase, MD (US)

Correspondence Address: TEXAS INSTRUMENTS INCORPORATED, P O BOX 655474, M/S 3999, DALLAS, TX, 75265

(21) Appl. No.: 10/615,574

(22) Filed: Jul. 8, 2003

Related U.S. Application Data
(60) Provisional application No. 60/394,416, filed on Jul. 8, 2002.
(60) Provisional application No. 60/400,385, filed on Jul. 31, 2002.

(51) Int. Cl. H04J 3/16

(52) U.S. Cl. 370/470

(57) ABSTRACT

ADSL systems with hybrid FDD/TDD duplexing using a hyperframe of mixtures of upstream-downstream FDD frames and all downstream frames.

### CROSS-REFERENCE TO RELATED APPLICATIONS

Priority is claimed from provisional Appl.Nos. 60/394,416, filed Jul. 8, 2002 and 60/400,385, filed Jul. 31, 2002. The following patent applications disclose related subject matter: Ser. Nos. 09/______,filed ______ (______). These applications have a common assignee with the present application.

### BACKGROUND OF THE INVENTION

The invention relates to digital communications, and, more particularly, to discrete multitone communication systems and corresponding circuitry and methods.

Digital subscriber line (DSL) technologies provide potentially large bandwidth (e.g., greater than 20 MHz for subscribers close to the central office) for digital communication over existing telephone subscriber lines (the copper plant). The subscriber lines can provide this bandwidth despite their original design for voice band (0-4 kHz) analog communication. In particular, ADSL (asymmetric DSL) adapts to the characteristics of the subscriber line by using a discrete multitone (DMT) line code with the number of bits per tone (subchannel) adjusted to channel conditions. The bits of a codeword are allocated among the subchannels for modulation to form an ADSL symbol for transmission. FIG. 3a illustrates the use of the Fast Fourier transform in a system. having, for example, 256 tones with each tone treated as a QAM subchannel (except dc tone 0) and so the kth tone encoding corresponds with a complex number X(k) for. 0≦k≦255. Extending to 512 tones by conjugate symmetry allows the 512-point IFFT to yield real samples x(n), 0≦n≦511, of the transformed block (symbol); and a DAC converts these samples into a segment of the transmitted waveform x(t). FIG. 3a also notes a cyclic prefix for each symbol which allows for simplified equalization for the interference of successive symbols which arises from the non-ideal impulse response of the transmission channel.

For example, Annex A of the ADSL standard G.992.3 has subchannels separated by 4.3125 KHz and a band extending up to 1104 KHz for 256 subchannels. Annex A also provides power spectral density (PSD) masks for both central office and customer transmitters.

Channel attenuation and noise can lead to a small number of subchannels providing a majority of the bit-carrying capacity, and thus to extend the reach of an ADSL system, the upstream and downstream both need access to these subchannels. A difficult aspect of extended reach system design is determining how to share these subchannels in a manner which is practical given realistic modem front end design constraints and spectral compatibility.

Typical duplexing methods have problems allocating a few good subchannels to both the upstream and downstream. For a typical frequency division duplex (FDD) system the upstream occupies the lower frequency subchannels and the downstream occupies the upper frequency subchannels; thus it is difficult to divide the subchannels between upstream and downstream as the desired crossover frequency is potentially in the middle of the high capacity subchannels. Indeed, because of filtering and echo canceller limitations, some of these high capacity subchannels are likely lost in a transition band.

Whereas, a typical time division duplex (TDD) system has large amounts of crosstalk variation and high latencies (both made worse by the typical asymmetric nature of the desired data rates) which limit system deployments. And a typical echo cancellation (EC) system has large disparity in transmit and receive powers, along with imperfections in echo cancellation; this makes fully overlapped operation difficult. A partially overlapped operation returns to the difficulties in allocating subchannels as in the FDD case.

### SUMMARY OF THE INVENTION

The present invention provides a hybrid FDD/TDD discrete multitone system by use of a hyperframe structure which mixes frames with differing upstream-downstream balance.

This has advantages including the flexibility to shift capacity between upstream and downstream as could be used in extended reach ADSL.

### BRIEF DESCRIPTION OF THE DRAWINGS

FIGS. 1a-1c illustrate preferred embodiment hybrid frames method.

FIG. 2 shows a preferred embodiment hyperframe.

FIGS. 3a-3b are functional block diagrams of a discrete multitone system.

FIG. 4 shows simulation results.

### DETAILED DESCRIPTION OF THE PREFERRED EMBODIMENTS

### 1. Overview

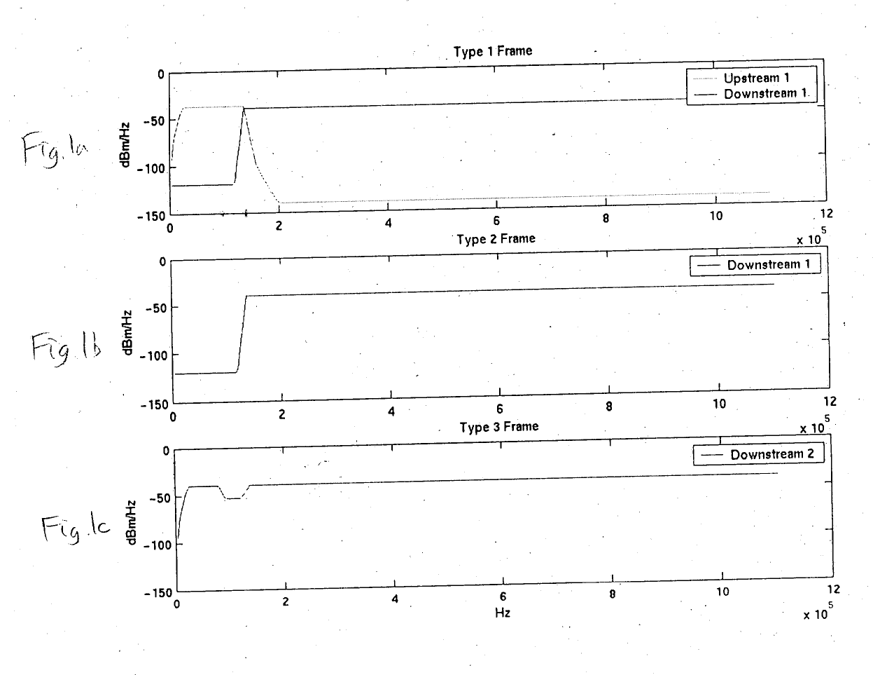

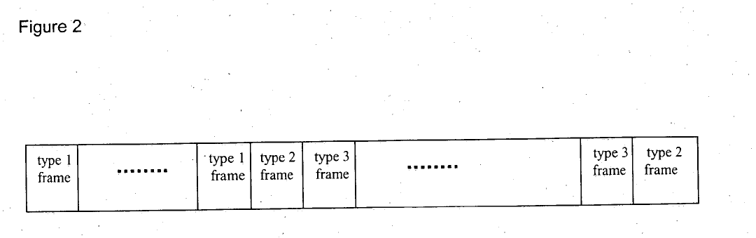

The preferred embodiment discrete multitone systems provide a hybrid FDD/TDD system with a hyperframe structure which allows the lower part of the spectrum to operate in a TDD fashion while the upper part of the spectrum operates in a FDD fashion. This has advantages for systems such as extended reach ADSL which need both upstream and downstream access to the high capacity subchannels which typically lie in the lower part of the spectrum (e.g., subchannels 6-16 in G.992.3). The hybrid FDD/TDD duplexing uses three types of frames as illustrated in FIGS. 1a-1c; and the duplexing operates by choosing a combination of type 1 and type 3 frames with type 2 frames as transitions within a 20-frame hyperframe; see FIG. 2.

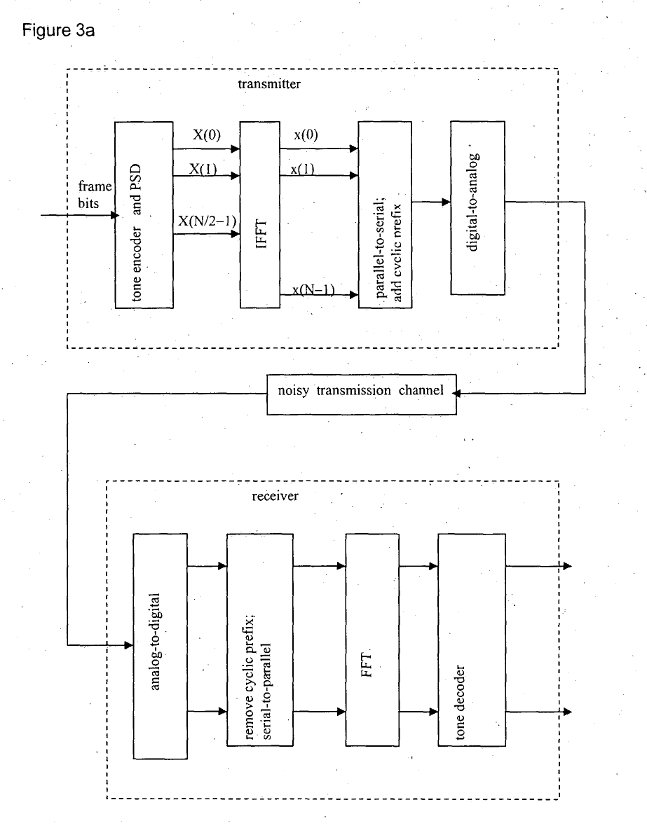

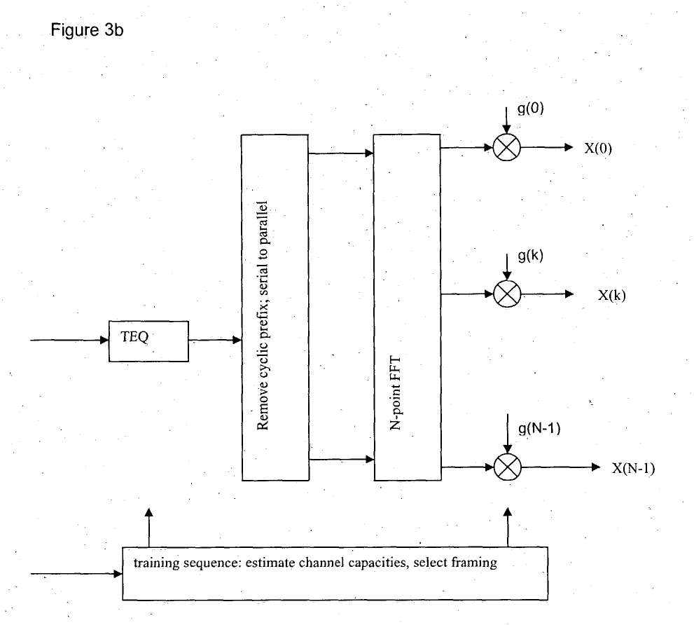

FIGS. 3a-3b illustrate functional blocks of a discrete multitone system which may use the preferred embodiment methods with PSD and framing part of the, encoding prior to the IFFT. The receiver of FIG. 3b has a single input TEQ (to effectively shorten the transmission channel impulse response) together with a 1-tap (multiplier) frequency domain equalizer (FEQ) for each tone.

Preferred embodiment communications systems use preferred embodiment methods. In preferred embodiment communications systems customer premises transceivers (modems) and central office transceivers (modems) could each include one or more digital signal processors (DSPs) and/or other programmable devices with stored programs for performance of the signal processing of the preferred embodiment methods. Alternatively, specialized circuitry could be used. The transceivers may also contain analog integrated circuits for amplification of inputs to or outputs and conversion between analog and digital; and these analog and processor circuits may be integrated as a system on a chip (SoC). The stored programs may, for example, be in ROM or flash EEPROM integrated with the processor or external. Exemplary DSP cores could be in the TMS320C6xxx or TMS320C5xxx families from Texas Instruments.

### 2. Hybrid FDD/TDD Preferred Embodiments

Preferred embodiment hybrid FDD/TDD duplexing methods use three types of frames, as illustrated in FIGS. 1a-1c. The type 1 frame has a power spectral density (PSD) labeled Upstream1 for use by the upstream (customer) transmitter and a PSD labeled Downstream1 for the downstream (central office) transmitter; the crossover frequency is about 138 kHz (e.g., tone 32 for ADSL) and the PSDs extend to about 1104 kHz (e.g., tone 256). The type 2 frame has no upstream and a Downstream1 PSD for the downstream transmitter. Lastly, a type 3 frame has no upstream and a Downstream2 PSD for the downstream transmitter where Downstream2 essentially covers the entire spectrum (with a PSD which is spectrally compatible according to regional regulations).

Preferred embodiment duplexing follows from choosing a combination of type 1, type 2, and type 3 frames to be included in a 20-frame hyperframe. The upstream data rate comes from type 1 frames which typically are FDD upstream and downstream with, for example, subchannels 6-31 for upstream and subchannels for 32-255 downstream. Thus type 1 frames could use FDD versions of SM5 or other such PSD masks. A type 2 frame is used to transition from a type 1 frame to a type 3 frame or from a type 3 frame to a type 1 frame. Type 2 frames are the same as type 1 frames without the upstream, which eliminates the need for echo cancellation. Type 3 frames allow the downstream to access all of the subchannels (including 1-32 or 6-32). This could follow the PSD of SM5, although it may be possible to use other PSDs which pass spectral compatibility tests. That is, the preferred embodiment hybrid systems achieve flexibility by adapting the mixture of frame types in a hyperframe to the desired data rates. And this approach extends to other frequency ranges (e.g., more or fewer tones) and to other PSDs.

FIG. 2 illustrates first preferred embodiment hyperframes which consist of 20 frames with type 1 frames occupying the initial part of the hyperframe followed by a type 2 transition frame, then the type 3 frames, and a final type 2 transition frame (for transition to the following hyperframe which necessarily begins with a type 1 frame). The list of 20 cases in the following table show the allowed numbers of each type of frame in a hyperframe.

| Case | type 1 | type 2 | type 3 | α_{us, 1} | α_{ds, 1} | α_{ds, 3} |
|---|---|---|---|---|---|---|
| 1 | 1 | 2 | 17 | 0.05 | 0.15 | 0.85 |
| 2 | 2 | 2 | 16 | 0.10 | 0.20 | 0.80 |
| 3 | 3 | 2 | 15 | 0.15 | 0.25 | 0.75 |
| 4 | 4 | 2 | 14 | 0.20 | 0.30 | 0.70 |
| 5 | 5 | 2 | 13 | 0.25 | 0.35 | 0.65 |
| 6 | 6 | 2. | 12 | 0.30 | 0.40 | 0.60 |
| 7 | 7 | 2 | 11 | 0.35 | 0.45 | 0.55 |
| 8 | 8 | 2 | 10 | 0.40 | 0.50 | 0.50 |
| 9 | 9 | 2 | 9 | 0.45 | 0.55 | 0.45 |
| 10 | 10 | 2 | 8 | 0.50 | 0.60 | 0.40 |
| 11 | 11 | 2 | 7 | 0.55 | 0.65 | 0.35 |
| 12 | 12 | 2 | 6 | 0.60 | 0.70 | 0.30 |
| 13 | 13 | 2 | 5 | 0.65 | 0.75 | 0.25 |
| 14 | 14 | 2 | 4 | 0.70 | 0.80 | 0.20 |
| 15 | 15 | 2 | 3 | 0.75 | 0.85 | 0.15 |
| 16 | 16 | 2 | 2 | 0.80 | 0.90 | 0.10 |
| 17 | 17 | 2 | 1 | 0.85 | 0.95 | 0.05 |
| 18 | 18 | 2 | 0 | 0.90 | 1.00 | 0.00 |
| 19 | 19 | 1 | 0 | 0.95 | 1.00 | 0.00 |
| 20 | 20 | 0 | 0 | 1.00 | 1.00 | 0.00 |

When there are no type 3 frames in a hyperframe (cases 18-20), there is no need for type 2 transition frames, and hence cases 18 and 19 would not be used in practice and case 20 used in their stead. Indeed, when the upstream data rate is the limiting factor, only case 20 hyperframes would be used, and the system effectively reduces to a static PSD (FDD or EC). Of course, with more or fewer frames per hyperframe, the set of the available data rates will increase or decrease.

The average number of bits, per symbol (from which the data rate can be calculated by multiplying by the symbol rate, typically 4000 symbols/s) depends upon the choice of hyperframe. The average bits per symbol for upstream and downstream, respectively, are given by:

Bᵤₛ=α_{us,1}B_{us.1}

B_{ds}=α_{ds,1}B_{ds,1}+α_{ds,3}B_{ds,3}

where the upstream factor α_{us,1} and the downstream factors α_{ds,1} and α_{ds,3} are the fraction of corresponding PSDs as listed in the foregoing table, and where B_{us,1} and B_{ds,1} are the number of upstream bits and downstream bits, respectively, in a type 1 frame and B_{ds,3} is the number of downstream bits in a type 3 frame.

The latency arising from the preferred embodiment hyperframe structure is effectively 0 in the downstream direction because a downstream signal is always transmitted (with the exception of when the subchannels are loaded with 0 bits). However, if the average number of downstream bits of a symbol is greater than the number of bits on a type 1 frame, then there will be some average latency introduced because the type 1 frame portion of a hyperframe cannot handle the average downstream bit rate.

The upstream direction latency due to the hyperframe portion of type 2 and type 3 frames is at most 19 frames which is still potentially less than that introduced by interleaving and Reed-Solomon coding.

Because subchannels 32-255 are always transmitted in the downstream direction, these subchannels do not introduce time-varying crosstalk. This is important because crosstalk coupling increases with increasing subchannel number; that is, capacitive coupling increases with frequency.

Time variations in subchannels 1-32 or 6-32 (which couple more weakly to neighboring lines) is controlled by the number of type 1 frames in a hyperframe. A smaller number of type 1 frames results in larger peak to average values of crosstalk at the customer end; whereas a larger number of type 1 frames results in larger peak to average values of crosstalk at the central office. By choosing roughly one half type 1 frames (case 10 in the foregoing table) the maximum difference in the peak to average value of the crosstalk is ˜3 dB.

At the central office end it is potentially possible to influence the overall amount of time variation introduced into the system over the first 32 subchannels by alternating the duty cycles so that type 1 frames on one modem will align with type 3 frames on a second modem. The overall time variations will then be reduced. Of course, with case 20 where the hyperframe is all type 1 frames, the time variation vanishes and the system operates with static transmit spectra.

The preferred embodiment hybrid FDD/TDD structure can be configured to match pure TDD or static (FDD or EC) duplexing. Indeed, omitting Downstream1 yields. a pure TDD system with type 1 frames using Upstream1 (e.g., subchannels 6-30) and type 3 frame using Downstream2 (e.g., subchannels 6-255). Conversely, the case 20 of all type 1 frames provides pure FDD or EC (depending upon the choice of Upstream1 and Downstream1). Indeed, section 5 below illustrates various experimental (simulation) comparisons of a preferred embodiment hybrid system with other systems under various interference conditions.

### 3. Setup and Training

With the preferred embodiment FDD/TDD system, differing cases of modem training arise: a first case provides training for a typical FDD/TDD system, and a second case additionally includes decision between a FDD/TDD system and a two-band system with multiple crossover subchannel possibilities. In particular, training for a typical FDD/TDD system (e.g., the G.992.3 ADSL standard) uses standard initiation procedures (e.g., G.hs.bis handshake standard), and for the preferred embodiment hybrid FDD/TDD system the following changes are needed:

(1) In G.hs make the choice of PSD masks for Upstream1, Downstream1, and Downstream2.

(2) Include both type 1 and type 3,frames in the signal-to-noise ratio (SNR) measurement phase (e.g., Medley in G.dmt).

(3) Both the central office and the customer do bit loading, and the central office chooses the hyperframe case to achieve the target data rate.

Training to include selection between operation as a typical FDD/TDD system or as a two-band system with a variable crossover subchannel (assuming a finite set of possibilities) requires the following changes:

(1) In G.hs make the choice of PSD masks for Upstreamen, Downstream1, and Downstream2, and also make the choice of the family of allowed two-band PSDs.

(2) Include both type 1 and type 3 frames in the signal-to-noise ratio (SNR) measurement phase (e.g., Medley in G.dmt) for FDD/TDD parameter estimation and multiple two-band FDD masks for variable band split estimation.

(3) Both the central office and the customer do bit loading for all cases.

(4) If exactly one of the two-band PSD masks is able to, achieve the target rate, it is chosen. If multiple two-band masks achieve the target rate, then the mask which is closest to normal FDD ADSL is chosen (because it will introduce the least amount of detrimental noise into the system).

(5) If none of the two-band PSD masks is able to achieve the target rate, then the central office chooses a hyperframe case for the hybrid FDD/TDD system to achieve the target rate.

(6) If the hybrid FDD/TDD system is unable to achieve the target rate, then the central office chooses the duplexing method with associated parameters that best approximates the target rate.

Modems for typical ADSL need the following features in order to implement a preferred embodiment hybrid FDD/TDD system:

(1) The central office transmit path needs a bypass of the subchannel 32 high pass filter; this allows type 3 frame transmission. Some plain old telephone service (POTS) avoidance filtering is also necessary.

(2) The central office receive path needs no change; only the Upstream1 of type 1 frames is processed and no adaptation takes place during type 2 or type 3 frames.

(3) The customer transmit path needs no hardware change but to further improve noise performance, certain parts of the transmitter can be appropriately switched during type 2 transition frames to further lower the receive noise floor during type 3 frames.

(4) The customer receive path needs to bypass the high pass filter at subchannel 32 to allow for the reception of type 3 frames. Adaptation of the lower subchannels is only done during type 3 frames.

(5) Buffering is necessary because the actual upstream and downstream transmit rates are not equivalent to the average transmit rate. For extended reach ADSL likely this buffering will be less than what is required for Annex C of the ADSL standard G.992.1 modems because of the lower data rates.

(6) Memory needs to hold two downstream bits and gains tables, as in Annex C of the ADSL standard G.992.1.

In summary, preferred embodiment hybrid FDD/TDD systems have advantages including: flexibility to shift capacity between the upstream and downstream to achieve target data rates; the ability to configure the duplexing in a pure TDD or pure static (FDD or EC) manner; robust operation and relaxed front end design requirements because there is no need to compensate for an echo; controllable latency in the upstream, and no latency in the downstream; controllable time varying crosstalk in the lower subchannels, and no time varying crosstalk in the upper subchannels; and straightforward training with a minimal number of changes to the existing ADSL training.

### 4. Simulations

Simulations comparing the performance of the preferred embodiment hybrid system with other systems under various interference conditions indicate that the preferred embodiment hybrid systems provide improved performance except when self-crosstalk dominates the interference, and in the self-crosstalk dominant environment the two-band FDD systems may provide better performance. Of course, the preferred embodiment hybrid system with the hyperframe consisting solely of type 1 frames is a two-band FDD system.

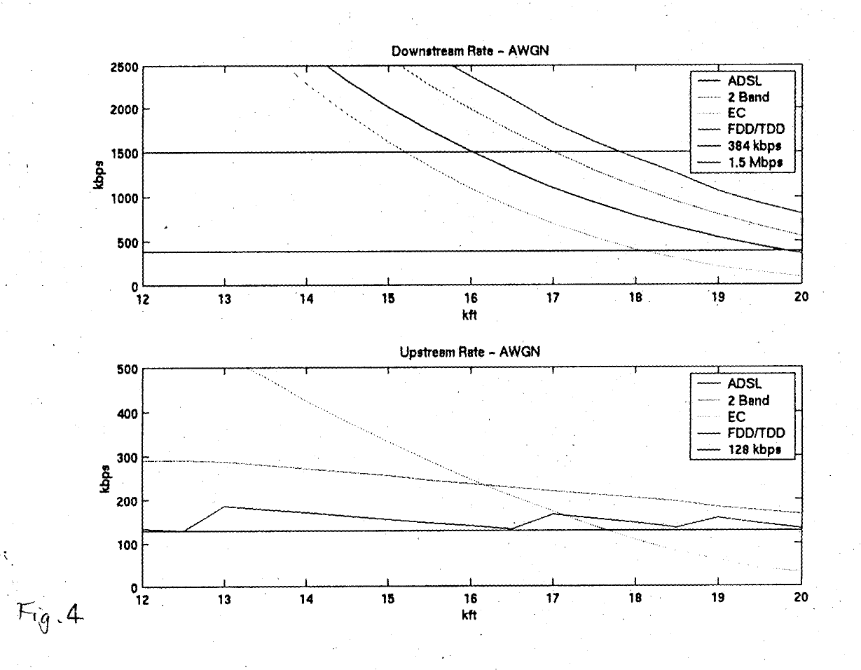

FIG. 4 shows the downstream and upstream simulated data rates of a normal ADSL system, two-band FDD extended reach ADSL system, fully overlapped ADSL system, and hybrid FDD/TDD ADSL system in −140 dBm/Hz additive white Gaussian noise. The hyperframe structure was chosen to maximize the downstream data rate while providing a minimum upstream data rate of 128 kbps. It can be seen that the hybrid FDD/TDD system provides the maximum downstream data rate while meeting the minimum upstream data rate requirement.

### 5. Modifications

The preferred embodiments may be varied while retaining one or more of the feature of a hybrid FDD/TDD system.

For example, the hybrid FDD/TDD hyperframes could have more or fewer than 20 frames; this would allow for compatibility with the superframe structure of ADSL G.992.3 which has 68 data frames plus 1 sync frame (sync symbol). Further, the Upstream1, Downstream1, and Downstream2 PSDs could all be modified, including overlap of subchannels; the type 2 frames could be replaced by type 3 frames when the transition between type 1 and type 3 frames is not needed (such as when an appropriate echo canceller is available). The type 2 frame at the end of the hyperframe could instead be placed at the start of the hyperframe. And so forth.

What is claimed is:

1. A discrete multitone hyperframe structure, comprising:
(a) for each n where n is an integer with 1≦n≦N and N is an integer greater than 2, a first sequence of n first frames for transmission in a first direction in a first set of subchannels and transmission in a second direction in a second set of subchannels where said first and second directions differ and said first and second sets are different; and
(b) a second sequence of at least N−2−n second frames for transmission in said second direction in both said first set and said second set of subchannels.

2. The structure of claim 1, further comprising:
(a) when n≦N−2 a third frame between said first sequence and said second sequence where said third frame is for transmission in said second direction in said second set of subchannels and no transmission in said first set of subchannels.

3. The structure of claim 1, wherein:
(a) the power spectral density for said transmission in said second direction in said second set of subchannels is the same for said first frames and said second frames.

4. The structure of claim 2, wherein:
(a) the power spectral density for said transmission in said second direction in said second set of subchannels is the same for each of said first, second, and third frames.

5. The structure of claim 1, wherein:
(a) N=20.

6. The structure of claim 1, wherein:
(a) N=68; and
(b) an addition sync symbol is transmitted between hyperframes.

7. The structure of claim 1, wherein:
(a) the first and second sets of subchannels are non-overlapping.

8 A method of initialization for a multitone system, comprising:
(a) comparing upstream and downstream data rates for a two-band duplex to threshold data rates; and
(b) when said data rates fail to meet said threshold data rates in step (a), comparing data rates for a hybrid duplex to said threshold data rates, wherein said hybrid duplex uses hyperframes with structure:
(i) for each n where n is an integer with 1≦n≦N and N is an integer greater than 2, a first sequence of n first frames for transmission in a first direction in a first set of subchannels and transmission in a second direction in a second set of subchannels where said first and second directions differ and said first and second sets are different; and
(ii) a second sequence of at least N−2−n second frames for transmission in said second direction in both said first set and said second set of subchannels.
